(19) United States
(12) Patent Application Publication
(10) Pub. No.: US 2003/0106225 A1
(43) Pub. Date: Jun. 12, 2003

(54) Hand-held tool for punching a reverse button lock projection in sheet metal

(76) Inventors: Timothy E. Walsh, Hicksville, NY (US); Thomas M. Howard, Lindenhurst, NY (US)

Correspondence Address: Charles E. Baxley, Hart, Baxley, Daniels & Holton, Fifth Floor, 59 John Street, New York, NY, 10038, US

(21) Appl. No.: 10/013,212

(22) Filed: Dec. 7, 2001

(51) Int. Cl. B26F 1/00

(52) U.S. Cl. 30/358

(57) ABSTRACT

A hand-held tool for punching a reverse button lock projection in sheet metal. The tool includes a stationary handle, a stationary jaw that extends from the stationary handle and together therewith forms a stationary portion, a movable handle, a movable jaw that extends from the movable handle and together therewith forms a movable portion that is pivotally attached to the stationary portion, a die that is interchangeably attached to the stationary jaw and faces one side of the sheet metal, and a punch that is interchangeably attached to the movable jaw and faces the other side of the sheet metal. When the movable handle is squeezed toward the stationary handle, the punch moves toward the die, and in so doing, forces the sheet metal into the die, and in so doing, the reverse button lock projection is formed in the sheet metal.

### BACKGROUND OF THE INVENTION

1. Field of the Invention

The present invention relates to the class of hand-held tool. More particularly, the present invention relates to a hand-held tool for punching a reverse button lock projection in sheet metal.

2. Description of the Prior Art

Pursuant to our U.S. Pat. No. 5,195,789, which is incorporated herein by reference thereto, a plurality of plurality of spaced wedge shaped projections (reverse button lock projections) are disposed near the free edge of each of the sides of the second duct. These projections engage and lock on the ledge in the second channel until the free edge is secured in the channel so that the second duct snaps into place at the ledge of the connector members.

Thus, there exists a need for a hand-held tool that can punch the plurality of spaced wedge shaped projections (reverse button lock projections) near the free edge of each of the ides of the second duct.

Numerous innovations for hand-held tools have been provided in the prior art. Even though these innovations may be suitable for t he specific individual purposes to which they address, however, they differ from the present invention in that they do not t each a hand-held tool for punching a reverse button lock in sheet metal and would therefore not be suitable for the purposes of the present invention as heretofore described.

### SUMMARY OF THE INVENTION

ACCORDINGLY, AN OBJECT of the present invention is to provide a hand-held tool for punching a reverse button lock projection in sheet metal that avoids the disadvantages of the prior art.

ANOTHER OBJECT of the present invention is to provide a hand-held tool for punching a reverse button lock projection in sheet metal that is simple to use.

BRIEFLY STATED, STILL ANOTHER OBJECT of the present invention is to provide a hand-held tool for punching a reverse button lock projection in sheet metal. The tool includes a stationary handle, a stationary jaw that extends from the stationary handle and together therewith forms a stationary portion, a movable handle, a movable jaw that extends from the movable handle and together therewith forms a movable portion that is pivotally attached to the stationary portion, a die that is interchangeably attached to the stationary jaw and faces one side of the sheet metal, and a punch that is interchangeably attached to the movable jaw and faces the other side of the sheet metal. When the movable handle is squeezed toward the stationary handle, the punch moves toward the die, and in so doing, forces the sheet metal into the die, and in so doing, the reverse button lock projection is formed in the sheet metal.

The novel features which are considered characteristic of the present invention are set forth in the appended claims. The invention itself, however, both as to its construction and its method of operation, together with additional objects and advantages thereof, will be best understood from the following description of the specific embodiments when read and understood in connection with the accompanying drawing.

### BRIEF DESCRIPTION OF THE DRAWING

The figures of the drawing are briefly described as follows:

FIG. 1 is a diagrammatic side elevational view of the hand-held tool of the present invention punching a reverse button lock projection in sheet metal;

FIG. 2 is a diagrammatic top plan view taken generally in the direction of ARROW 2 in FIG. 1 of the sheet metal with a plurality of reverse button lock projections punched therein;

FIG. 3 is a diagrammatic side elevational view of the area generally enclosed by the dotted curve identified by ARROW 3 in FIG. 1 of the hand-held tool of the present invention; and

FIG. 4 is an enlarged diagrammatic cross sectional view taken along LINE 4-4 in FIG. 3.

### LIST OF REFERENCE NUMERALS UTILIZED IN THE DRAWING

10 hand-held tool of present invention for punching reverse button lock projection 12 in sheet metal 14

12 reverse button lock projection in sheet metal 14

14 sheet metal

16 stationary handle

18 stationary jaw

20 stationary portion

22 movable handle

24 movable jaw

26 movable portion

28 die for facing one side of sheet metal 14

30 punch for facing other side of sheet metal 14

32 enclosure of stationary jaw 18

34 top wall of enclosure 32 of stationary jaw 18

36 bottom wall of enclosure 32 of stationary jaw 18

38 pair of side walls of enclosure 32 of stationary jaw 18

40 front wall of enclosure 32 of stationary jaw 18

42 rear wall of enclosure 32 of stationary jaw 18

44 chamber defined by top wall 34 of enclosure 32 of stationary jaw 18, bottom wall 36 of enclosure 32 of stationary jaw 18, and pair of side walls 38 of enclosure 32 of stationary jaw 18

46 base of stationary jaw 18

48 uppermost surface of base 46 of stationary jaw 18

50 terminal end of base 46 of stationary jaw 18

52 first throughbore through one side wall of pair of side walls 38 of enclosure 32 of stationary jaw 18

54 second throughbore through one side wall of pair of side walls 38 of enclosure 32 of stationary jaw 18

56 third throughbore through other side wall of pair of side walls 38 of enclosure 32 of stationary jaw 18

58 fourth throughbore through other side wall of pair of side walls 38 of enclosure 32 of stationary jaw 18

60 proximal end of stationary handle 16

62 distal end, of stationary handle 16

64 rubber cap encasing distal end 62 of stationary handle 16

66 proximal end of movable handle 22

68 distal end of movable handle 22

70 intermediate point of movable handle 22

72 rubber cap encasing distal end 68 of movable handle 22

74 pivot arm of movable jaw 24

76 distal end of pivot arm 74 of movable jaw 24

78 proximal end of pivot arm 74 of movable jaw 24

80 intermediate point of pivot arm 74 of movable jaw 24

81 blindbore in proximal end 78 of pivot arm 74 of movable jaw 24

82 throughbore through intermediate point 80 of pivot arm 74 of movable jaw 24

84 forward portion of pivot arm 74 of movable jaw 24

86 rear portion of pivot arm 74 of movable jaw 24

87 blindbore in rear portion 86 of pivot arm 74 of movable jaw 24

88 pivot bolt of pivot arm 74 of movable jaw 24

90 coil spring of movable jaw 24

92 first end of coil spring 90 of movable jaw 24

94 second end of coil spring 90 of movable jaw 24

96 stub rod of movable jaw 24

98 threaded end of stub rod 96 of movable jaw 24

100 head of stub rod 96 of movable jaw 24

102 bolt of die 28

104 throughbore through punch 30

106 lip of punch 30

108 bolt of punch 30

### DETAILED DESCRIPTION OF THE PREFERRED EMBODIMENT

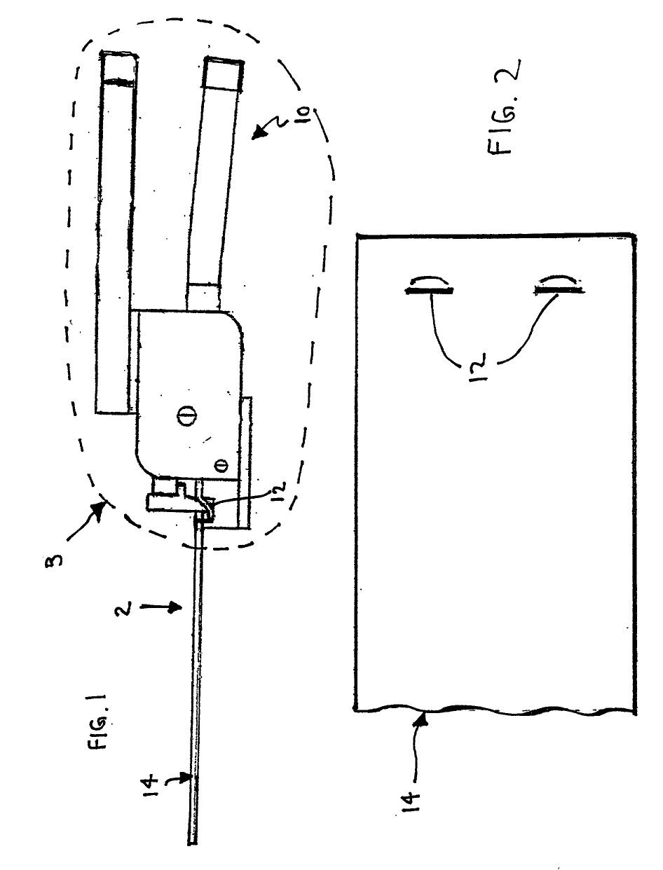

Referring now to the figures, in which like numerals indicate like parts, and particularly to FIGS. 1 and 2, which are, respectively, a diagrammatic side elevational view of the hand-held tool of the present invention punching a reverse button lock projection in sheet metal, and a diagrammatic top plan view taken generally in the direction of ARROW 2 in FIG. 1 of the sheet metal with a plurality of reverse button lock projections punched therein, the hand-held tool of the present invention is shown generally at 10 for punching a reverse button lock projection 12 in sheet metal 14.

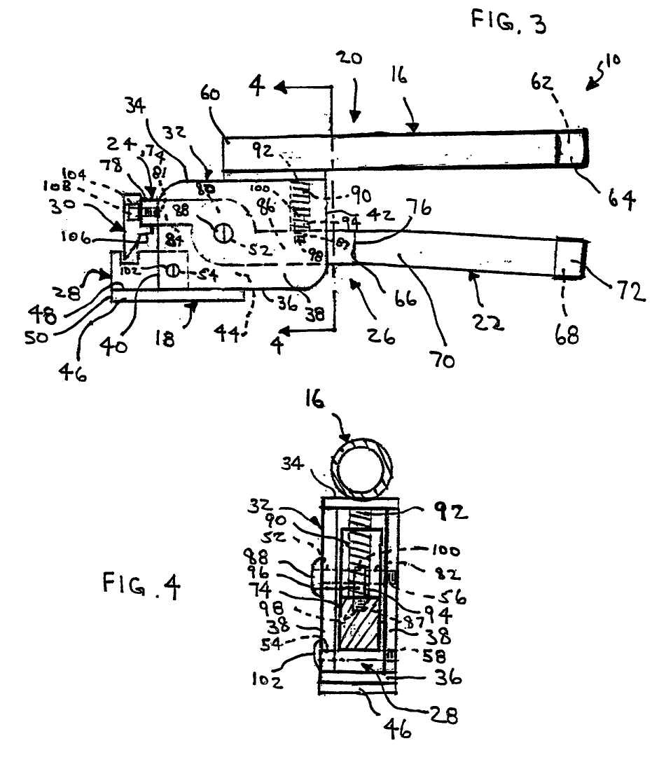

The configuration of the hand-held tool 10 can best be seen in FIGS. 3 and 4, which are, respectively, a diagrammatic side elevational view of the area generally enclosed by the dotted curve identified by ARROW 3 in FIG. 1 of the hand-held tool of the present invention, and an enlarged diagrammatic cross sectional view taken along LINE 4-4 in FIG. 3, and as such, will be discussed with reference thereto.

The hand-held tool 10 comprises a stationary handle 16, a stationary jaw 18 that extends from the stationary handle 16 and together therewith forms a stationary portion 20, a movable handle 22, a movable jaw 24 that extends from, and moves with, the movable handle 22 and together therewith forms a movable portion 26 that is pivotally attached to the stationary portion 20, a die 28 that is attached to the stationary jaw 18 and faces one side of the sheet metal 14, and a punch 30 that is attached to, and moves with, the movable jaw 24 and faces the other side of the sheet metal 14. When the movable handle 22 is squeezed toward the stationary handle 16, the punch 30 moves toward the die 28, and in so doing, forces the sheet metal 14 into the die 28, and in so doing, the reverse button lock projection 12 is formed in the sheet metal 14.

The stationary jaw 18 comprises an enclosure 32 that is substantially rectangular-parallelepiped-shaped, and as a result thereof, has a top wall 34, a bottom wall 36, a pair of side walls 38, a front wall 40 that is open, and a rear wall 42 that is open. The top wall 34, the bottom wall 36, and the pair of side walls 38 of the enclosure 32 together define a chamber 44 therebetween which the front wall 40 and the rear wall 42 of the enclosure 32 communicate with. The stationary jaw 18 further comprises a base 46 that is flat, has an uppermost surface 48, and is disposed on the bottom wall 36 of the enclosure 32 and extends forwardly therefrom to a terminal end 50.

One side wall 38 of the enclosure 32 has a first throughbore 52 that is not threaded and extends generally centrally therethrough, and a second throughbore 54 that is not threaded and is disposed in close proximity to the front wall 40 and the bottom wall 36 of the enclosure 32. The other side well 38 of the enclosure 32 has a third throughbore 56 that is threaded, extends generally centrally therethrough, and is aligned with the first throughbore 52 through the one side wall 38 of the enclosure 32, and a fourth throughbore 58 that is threaded, is disposed in close proximity to the front wall 40 and the bottom wall 36 of the enclosure 32, and is aligned with the second throughbore 54 through the one side wall 38 of the enclosure 32.

The stationary handle 16 is slender, elongated, straight, tubular, and has a proximal end 60 and a distal end 62. The proximal end 60 of the stationary handle 16 is disposed on the top wall 34 of the enclosure 32 of the stationary jaw 18, with the stationary handle 16 extending rearwardly therefrom, and the distal end 62 of the stationary handle 16 is encased in a rubber cap 64.

The movable handle 22 is slender, elongated, tubular, and has a proximal end 66, a distal end 68, and an intermediate point 70 that is intermediate the proximal end 66 thereof and the distal end 68 thereof, with the distal end 68 thereof being encased in a rubber cap 72. The movable handle 22 curves downwardly from the intermediate point 70 thereof to the distal end 68 thereof to conform to the curvature formed by the fingers when the fingers are bent against the movable handle 22 as a result of the effect of the superficial transverse ligament of the fingers. The superficial transverse ligament of the fingers is a thin, fibrous band which stretches across the roots of the four fingers, and is closely attached to the skin of the clefts, and internally to the fifth metacarpal bone, forming a sort of rudimentary web. Gray's Anatomy; Henry Gray; Bounty Books; p. 404.

The movable jaw 24 comprises a pivot arm 74 that extends from the proximal end 66 of the movable handle 22, forwardly through the rear wall 42 of the enclosure 32, and into the chamber 44 in the enclosure 32. The pivot arm 74 of the movable jaw 24 has a distal end 76 that is coincident with the proximal end 66 of the movable handle 22, a proximal end 78 that extends forwardly through the front wall 40 of the enclosure 32, an intermediate point 80 that is disposed intermediate the proximal end 78 thereof and the distal end 76 thereof, a throughbore 82 that extends through the intermediate point 80 thereof, a blindbore 81 that is threaded and extends axially in the proximal end 78 thereof, a forward portion 84 that extends from the intermediate point 80 thereof to the proximal end 78 thereof, and a rear portion 86 that extends from the intermediate point 80 thereof to the distal end 76 thereof, is offset below the forward portion 84 thereof, and has a blindbore 87 that depends therein. The pivot arm 74 is pivotally mounted in the chamber 44 in the enclosure 32 by a pivot bolt 88 that enters freely into the first throughbore 52 in the one side wall 38 of the enclosure 32, freely through the throughbore 82 in the pivot arm 74, and threadably into the third throughbore 56 in the other side wall 38 of the enclosure 32.

The movable jaw 24 further comprises a coil spring 90 that depends in the chamber 44 in the enclosure 32 and biases the punch 30 away from the die 28. The coil spring 90 has a first end 92 that is affixed to the top wall 34 of the enclosure 32 and a second end 94 that is affixed to the rear portion 86 of the pivot arm 74. The movable jaw 24 further comprises a stub rod 96 that extends axially in the coil spring 90. The stub rod 96 has a threaded end 98 that is threaded into the blindbore 87 in the rear portion 86 of the pivot arm 74 an amount dependent upon desired penetration of the punch 30 into the die 28, and a head 100 that is free and faces the first end 92 of the coil spring 90. The head 100 of the stub rod 96 provides a stop for the pivot arm 74 during use, and in so doing, adjustably limits penetration of the punch 30 into the die 28.

The die 28 is disposed at the terminal end 50 of the base 46 of the stationary jaw 18, on the uppermost surface 48 thereof, and extends rearwardly therefrom through the front wall 40 of the enclosure 32, into the chamber 44 in the enclosure 32. The die 28 is interchangeably attached to the stationary jaw 18 by a bolt 102 that extends freely into the second throughbore 54 in the one side wall 38 of the enclosure 32, freely through the die 28, and threadably into the fourth throughbore 58 in the other side wall 38 of the enclosure 32.

The punch 30 depends from the proximal end 78 of the pivot arm 74 of the movable jaw 24, and has a throughbore 104 that extends rearwardly therethrough and a lip 106 that extends rearwardly therefrom to seat directly under, and against, the proximal end 78 of the pivot arm 74 of the movable jaw 24 for distributing load on the punch 30 during use. The punch 30 is interchangeably attached to the proximal end 78 of the pivot arm 74 by a bolt 108 that extends freely into the throughbore 104 therethrough and threadably into the blindbore 81 in the proximal end 78 of the pivot arm 74.

It will be understood that each of the elements described above, or two or more together, may also find a useful application in other types of constructions differing from the types described above.

While the invention has been illustrated and described as embodied in a hand-held tool for punching a reverse button lock projection in sheet metal, however, it is not limited to the details shown, since it will be understood that various omissions, modifications, substitutions and changes in the forms and details of the device illustrated and its operation can be made by those skilled in the art without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute characteristics of the generic or specific aspects of this invention.

The invention claimed is:

1. A hand-held tool for punching a reverse button lock projection in sheet metal, comprising:
a) a stationary handle;
b) a stationary jaw;
c) a movable handle;
d) a movable jaw;
e) a die; and
f) a punch;
wherein said stationary jaw extends from said stationary handle;
wherein said stationary jaw and said stationary handle together form a stationary portion;
wherein said movable jaw extends from said movable handle;
wherein said movable jaw moves with said movable handle;
wherein said movable jaw and said movable handle together form a movable portion;
wherein said movable portion is pivotally attached to said stationary portion;
wherein said die is attached to said stationary jaw;
wherein said die is for facing one side of the sheet metal;
wherein said punch is attached to said movable jaw;
wherein said punch moves with said movable jaw; and
wherein said punch is for facing the other side of the sheet metal, and when said movable handle is squeezed toward said stationary handle, said punch moves toward said die, and in so doing, forces the sheet metal into said die, and in so doing, the reverse button lock projection is formed in the sheet metal.

2. The tool as defined in claim 1, wherein said stationary handle is slender;
wherein said stationary handle is elongated;
wherein said stationary handle is straight; and
wherein said stationary handle is tubular.

3. The tool as defined in claim 1, wherein said stationary handle has a proximal end;
wherein said stationary jaw comprises an enclosure;
wherein said enclosure of said stationary jaw extends from said proximal end of said stationary handle;
wherein said enclosure of said stationary jaw has a top wall;
wherein said enclosure of said stationary jaw has a bottom wall;
wherein said enclosure of said stationary jaw has a pair of side walls;
wherein said top wall, said bottom wall, and said pair of side walls of said enclosure together define a chamber therebetween;
wherein said enclosure of said stationary jaw has a front wall;
wherein said front wall of said enclosure is open;
wherein said front wall of said enclosure communicates with said chamber in said enclosure;
wherein said enclosure of said stationary jaw has a rear wall;
wherein said rear wall of said enclosure is open; and
wherein said rear wall of said enclosure communicates with said chamber in said enclosure.

4. The tool as defined in claim 3, wherein said enclosure of said stationary jaw is substantially rectangular-parallelepiped-shaped.

5. The tool as defined in claim 3, wherein said proximal end of said stationary handle is disposed on said top wall of said enclosure; and
wherein said stationary handle extends rearwardly from said top wall of said enclosure.

6. The tool as defined in claim 3, wherein said stationary jaw has a base;
wherein said base of said stationary jaw is disposed on said bottom wall of said enclosure; and
wherein said base of said stationary jaw extends forwardly from said bottom wall of said enclosure to a terminal end.

7. The tool as defined in claim 6, wherein said base of said stationary jaw is flat; and
wherein said base of said stationary jaw has an uppermost surface.

8. The tool as defined in claim 3, wherein one side wall of said enclosure has a first throughbore;
wherein said first throughbore in said one side wall of said enclosure is not threaded;
wherein said first throughbore extends generally centrally through said one side wall of said enclosure;
wherein said one side wall of said enclosure has a second throughbore;
wherein said second throughbore in said one side wall of said enclosure is not threaded;
wherein said second throughbore is disposed in close proximity to said front wall and said bottom wall of said enclosure;
wherein the other side wall of said enclosure has a third throughbore;
wherein said third throughbore in said other side wall of said enclosure is threaded;
wherein said third throughbore extends generally centrally through said other side wall of said enclosure;
wherein said third throughbore in said other side wall of said enclosure is aligned with said first throughbore in said one side wall of said enclosure;
wherein said other side wall of said enclosure has a fourth throughbore;
wherein said fourth throughbore in said other side wall of said enclosure is threaded;
wherein said fourth throughbore is disposed in close proximity to said front wall and said bottom wall of said enclosure; and
wherein said fourth throughbore in said other side wall of said enclosure is aligned with said second throughbore in said one side wall of said enclosure.

9. The tool as defined in claim 8, wherein said movable handle is slender;
wherein said movable handle is elongated;
wherein said movable handle is tubular;
wherein said movable handle has a proximal end;
wherein said movable handle has a distal end;
wherein said movable handle has an intermediate point; and
wherein said intermediate point of said movable handle is intermediate said proximal end thereof and said distal end thereof.

10. The tool as defined in claim 9, wherein said movable handle curves downwardly from said intermediate point thereof to said distal end thereof for conforming to the curvature formed by the fingers when the fingers are bent against said movable handle as a result of the effect of the superficial transverse ligament of the fingers.

11. The tool as defined in claim 1, wherein said stationary handle has a distal end;
wherein said stationary handle has a rubber cap;
wherein said rubber cap encases said distal end of said stationary handle;
wherein said movable handle has a distal end;
wherein said movable handle has a rubber cap; and
wherein said rubber cap encases said distal end of said movable handle.

12. The tool as defined in claim 9, wherein said movable jaw comprises a pivot arm;
wherein said pivot arm of said movable jaw extends from said proximal end of said movable handle;
wherein said pivot arm of said movable jaw extends forwardly through said rear wall of said enclosure of said stationary jaw;
wherein said pivot arm of said movable jaw extends into said chamber in said enclosure of said stationary jaw;
wherein said pivot arm of said movable jaw has a distal end;
wherein said distal end of said pivot arm is coincident with said proximal end of said movable handle;
wherein said pivot arm of said movable jaw has a proximal end;
wherein said proximal end of said pivot arm extends forwardly through said front wall of said enclosure of said stationary jaw;
wherein said proximal end of said pivot arm has a blindbore;
wherein said blindbore extends axially in said proximal end of said pivot arm;
wherein said blindbore in said proximal end of said pivot arm is threaded;
wherein said pivot arm has an intermediate point; and
wherein said intermediate point of said pivot arm is disposed intermediate said proximal end thereof and said distal end thereof.

13. The tool as defined in claim 12, wherein said intermediate point of said pivot arm has a throughbore that extends therethrough; and
wherein said pivot arm is pivotally mounted in said chamber in said enclosure by a pivot bolt that enters freely into said first throughbore in said one side wall of said enclosure, freely through said throughbore in said pivot arm, and threadably into said third throughbore in said other side wall of said enclosure.

14. The tool as defined in claim 12, wherein said pivot arm has a forward portion;
wherein said forward portion of said pivot arm extends from said intermediate point thereof to said proximal end thereof,
wherein said pivot arm has a rear portion;
wherein said rear portion of said pivot arm extends from said intermediate point thereof to said distal end thereof;
wherein said rear portion of said pivot arm has a blindbore that depends therein; and
wherein said rear portion of said pivot arm is offset below said forward portion thereof.

15. The tool as defined in claim 14, wherein said movable jaw has a coil spring;
wherein said coil spring biases said punch away from said die;
wherein said coil spring depends in said chamber in said enclosure;
wherein said coil spring has a first end;
wherein said first end of said coil spring is affixed to said top wall of said enclosure;
wherein said coil spring has a second end; and
wherein said second end of said coil spring is affixed to said rear portion of said pivot arm.

16. The tool as defined in claim 15, wherein said movable jaw has a stub rod;
wherein said stub rod extends axially in said coil spring;
wherein said stub rod has a threaded end;
wherein said threaded end of said stub rod is threaded into said blindbore in said rear portion of said pivot arm an amount dependent upon desired penetration of said punch into said die;
wherein said stub rod has a head;
wherein said head of said stub rod is free;
wherein said head of said stub rod faces said first end of said coil spring; and
wherein said head of said stub rod provides a stop for said pivot arm during use, and in so doing, adjustably limits penetration of said punch into said die.

17. The tool as defined in claim 7, wherein said die is disposed at said terminal end of said base of said stationary jaw;
wherein said die is disposed on said uppermost surface of said base of said stationary jaw;
wherein said die extends through said front wall of said enclosure; and
wherein said die extends into said chamber in said enclosure.

18. The tool as defined in claim 8, wherein said die is interchangeably attached to said stationary jaw by a bolt; and
wherein said bolt of said die extends freely into said second throughbore in said one side wall of said enclosure, freely through said die, and threadably into said fourth throughbore in said other side wall of said enclosure.

19. The tool as defined in claim 12, wherein said punch depends from said proximal end of said pivot arm of said movable jaw;
wherein said punch has a throughbore;
wherein said throughbore extends rearwardly through said punch;
wherein said punch has a lip; and
wherein said lip extends rearwardly from said punch to seat directly under, and against, said proximal end of said pivot arm of said movable jaw for distributing load of said punch during use.

20. The tool as defined in claim 19, wherein said punch is interchangeably attached to said proximal end of said pivot arm by a bolt; and
wherein said bolt of said punch extends freely into said throughbore in said punch and threadably into said blindbore in said proximal end of said pivot arm.
